(19) United States
(12) Patent Application Publication
(10) Pub. No.: US 2025/0373825 A1
(43) Pub. Date: Dec. 4, 2025

(54) SIGNALING CORRECTIONS FOR A CONVOLUTIONAL CROSS-COMPONENT MODEL

(71) Applicant: InterDigital CE Patent Holdings, SAS, Paris (FR)

(72) Inventors: Federico LO BIANCO, Cesson-Sevigne (FR); Karam NASER, Cesson-Sevigne (FR); Philippe BORDES, Cesson-Sevigne (FR); Frederic LEFEBVRE, Cesson-Sevigne (FR)

(21) Appl. No.: 18/877,992

(22) PCT Filed: Jun. 21, 2023
(86) PCT No.: PCT/EP2023/066746

§ 371 Date: Dec. 20, 2024

(30) Foreign Application Priority Data
Jul. 1, 2022 (EP) 22305975.9

(51) Int. Cl. H04N 19/186

(52) U.S. Cl. CPC H04N 19/186

(57) ABSTRACT

Apparatuses and methods are disclosed including techniques for encoding video data. Techniques disclosed include obtaining video data, including data representing a video data region, and obtaining correction value(s) that represent a correction to a cross-component model for predicting a chroma sample from the video data region based on a corresponding luma sample. Then, encoding the correction value(s) and the video data into coded video data. Apparatuses and methods are also disclosed that include techniques for decoding coded video data. Techniques disclosed include receiving coded video data, coding video data including data representing a video data region and correction value(s). Then, decoding the correction value(s) from the coded video data. The decoded correction value(s) are used to adjust the cross-component model, applied for intra-prediction of a chroma sample from the video data region.

### CROSS-REFERENCE TO RELATED APPLICATIONS

This application claims the benefit of EP Provisional Application No. 22/305,975.9, filed Jul. 1, 2022, the contents of which are hereby incorporated herein by reference in their entirety.

### BACKGROUND

To achieve high compression efficiency, image and video coding schemes usually employ prediction and transformation to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transformation, and prediction.

### SUMMARY

Aspects disclosed in the present disclosure describe methods for encoding video data by an encoder. The methods comprise: obtaining video data, including data representing a video data region; obtaining at least one correction value, the at least one correction value representing a correction to a cross-component model for predicting a chroma sample from the video data region based on a corresponding luma sample; and encoding the at least one correction value and the video data into coded video data.

Aspects disclosed in the present disclosure describe methods for decoding video data by a decoder. The methods comprise: receiving coded video data, coding video data including data representing a video data region and at least one correction value; and decoding the at least one correction value from the coded video data. The at least one correction value representing a correction to a cross-component model for predicting a chroma sample from the video data region based on a corresponding luma sample.

Aspects disclosed in the present disclosure describe an apparatus for encoding video data. The apparatus comprises at least one processor and memory storing instructions. The instructions, when executed by the at least one processor, cause the apparatus to: obtain video data, including data representing a video data region; obtain at least one correction value, the at least one correction value representing a correction to a cross-component model for predicting a chroma sample from the video data region based on a corresponding luma sample; and encode the at least one correction value and the video data into coded video data.

Aspects disclosed in the present disclosure describe an apparatus for decoding video data. The apparatus comprises at least one processor and memory storing instructions. The instructions, when executed by the at least one processor, cause the apparatus to: receive coded video data, coding video data including data representing a video data region and at least one correction value; and decoding the at least one correction value from the coded video data. The at least one correction value representing a correction to a cross-component model for predicting a chroma sample from the video data region based on a corresponding luma sample.

Aspects disclosed in the present disclosure describe a non-transitory computer-readable medium comprising instructions executable by at least one processor to perform methods. The methods comprise: obtaining video data, including data representing a video data region; obtaining at least one correction value, the at least one correction value representing a correction to a cross-component model for predicting a chroma sample from the video data region based on a corresponding luma sample; and encoding the at least one correction value and the video data into coded video data.

Aspects disclosed in the present disclosure describe a non-transitory computer-readable medium comprising instructions executable by at least one processor to perform methods. The methods comprise: receiving coded video data, coding video data including data representing a video data region and at least one correction value; and decoding the at least one correction value from the coded video data. The at least one correction value representing a correction to a cross-component model for predicting a chroma sample from the video data region based on a corresponding luma sample.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

FIG. 1 is a block diagram of an example system, with which aspects of the present embodiments can be implemented.

FIG. 2 is a block diagram of an example video encoder, with which aspects of the present embodiments can be implemented.

FIG. 3 is a block diagram of an example video decoder, with which aspects of the present embodiments can be implemented.

FIG. 4 is a diagram that illustrates a cross-component linear model (CCLM) used in cross-component (CC) based prediction, according to which aspects of the present embodiments can be implemented.

FIG. 5 is a diagram that illustrates a multi-model linear model (MMLM) used in CC based prediction, according to which aspects of the present embodiments can be implemented.

FIG. 6 is a diagram that illustrates a multiple reference line (MRL) used in CC based prediction, according to which aspects of the present embodiments can be implemented.

FIG. 7 is a diagram that illustrates a reference area used by a convolutional cross-component model (CCCM), according to which aspects of the present embodiments can be implemented.

FIG. 8 is a flowchart of an example method for CC based prediction, according to which aspects of the present embodiments can be implemented.

FIG. 9 is a diagram that illustrates a correction to a CCLM, according to which aspects of the present embodiments can be implemented.

FIG. 10 is a flowchart of an example method for encoding video data, according to which aspects of the present embodiments can be implemented.

FIG. 11 is a flowchart of an example method for decoding video data, according to which aspects of the present embodiments can be implemented.

### DETAILED DESCRIPTION

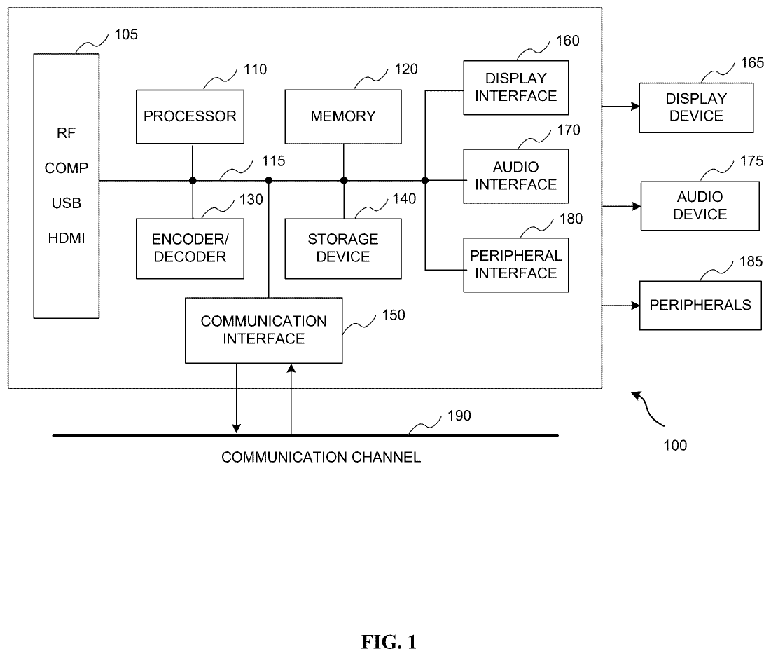

FIG. 1 illustrates a block diagram of an example system 100 with which aspects of the present embodiments can be implemented. System 100 can be embodied as a device including the various components described below and can be configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, can be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 that can be configured to execute instructions loaded therein for implementing, for example, the various aspects described in this application. Processor 110 can include embedded memory, input and output interfaces, and various other circuitries as known in the art. The system 100 includes at least one memory 120 (e.g., a volatile memory device and/or a non-volatile memory device). System 100 includes a storage device 140, which can include non-volatile memory and/or volatile memory, including, but not limited to, EEPROM, ROM, PROM, RAM, DRAM, SRAM, flash, magnetic disk drive, and/or optical disk drive. The storage device 140 can be an internal storage device, an attached storage device, and/or a network accessible storage device, as non-limiting examples.

System 100 includes an encoder/decoder module 130 configured, for example, to process data to provide an encoded video or decoded video. The encoder/decoder module 130 can include its own processor and memory. The encoder/decoder module 130 represents module(s) that can be included in a device to perform the encoding and/or decoding functions. As is known, a device can include one or both of the encoding and decoding modules. Additionally, encoder/decoder module 130 can be implemented as a separate element of system 100 or can be incorporated within processor 110 as a combination of hardware and software as known to those skilled in the art.

Program code to be loaded onto processor 110 or encoder/decoder 130 to perform the various aspects described in this application can be stored in storage device 140 and subsequently loaded onto memory 120 for execution by processor 110. In accordance with various embodiments, one or more of processor 110, memory 120, storage device 140, and encoder/decoder module 130 can store one or more of various items during the performance of the processes described in this application. Such stored items can include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device can be either the processor 110 or the encoder/decoder module 130) is used for one or more of these functions. The external memory can be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC.

The input to the elements of system 100 can be provided through various input devices as indicated in block 105. Such input devices include, but are not limited to, (i) an RF portion that receives an RF signal transmitted, for example, over the air by a broadcaster, (ii) a Composite input terminal (COMP), (iii) a USB input terminal, and/or (iv) an HDMI input terminal.

In various embodiments, the input devices of block 105 have associated respective input processing elements as known in the art. For example, the RF portion can be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which can be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs some of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Added elements can include inserting elements in between existing elements, for example, inserting amplifiers and an analog-to-digital converter. In various embodiments, the RF portion includes an antenna.

Additionally, the USB and/or HDMI terminals can include respective interface processors for connecting system 100 to other electronic devices across USB and/or HDMI connections. It is to be understood that various aspects of input processing, for example, Reed-Solomon error correction, can be implemented, for example, within a separate input processing IC or within processor 110 as necessary. Similarly, aspects of USB or HDMI interface processing can be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 can be provided within an integrated housing. Within the integrated housing, the various elements can be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 can include, but is not limited to, a transceiver configured to transmit and to receive data over communication channel 190. The communication interface 150 can include, but is not limited to, a modem or network card and the communication channel 190 can be implemented, for example, within a wired and/or a wireless medium.

Data is streamed to the system 100, in various embodiments, using a Wi-Fi network such as IEEE 802.11. The Wi-Fi signal of these embodiments is received over the communication channel 190 and the communication interface 150 which are adapted for Wi-Fi communications. The communication channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 can provide an output signal to various output devices, including a display device 165, an audio device (e.g., speaker(s)) 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display device 165, the audio device 175, or other peripheral devices 185 using signaling such as AV.link, CEC, or other communication protocols that enable device-to-device control with or without user intervention. The output devices can be communicatively coupled to system 100 via dedicated connections through respective interfaces 160, 170, and 180. Alternatively, the output devices can be connected to system 100 using the communication channel 190 via the communication interface 150. The display device 165 and the audio device 175 can be integrated in a single unit with the other components of system 100 in an electronic device, for example, a television. In various embodiments, the display interface 160 includes a display driver, for example, a timing controller (T Con) chip.

The display device 165 and the audio device 175 can alternatively be separate from one or more of the other components, for example, if the RF portion of input 105 is part of a separate set-top box. In various embodiments in which the display device 165 and the audio device 175 are external components, the output signal can be provided via dedicated output connections, including, for example, HDMI ports, USB ports, or COMP outputs.

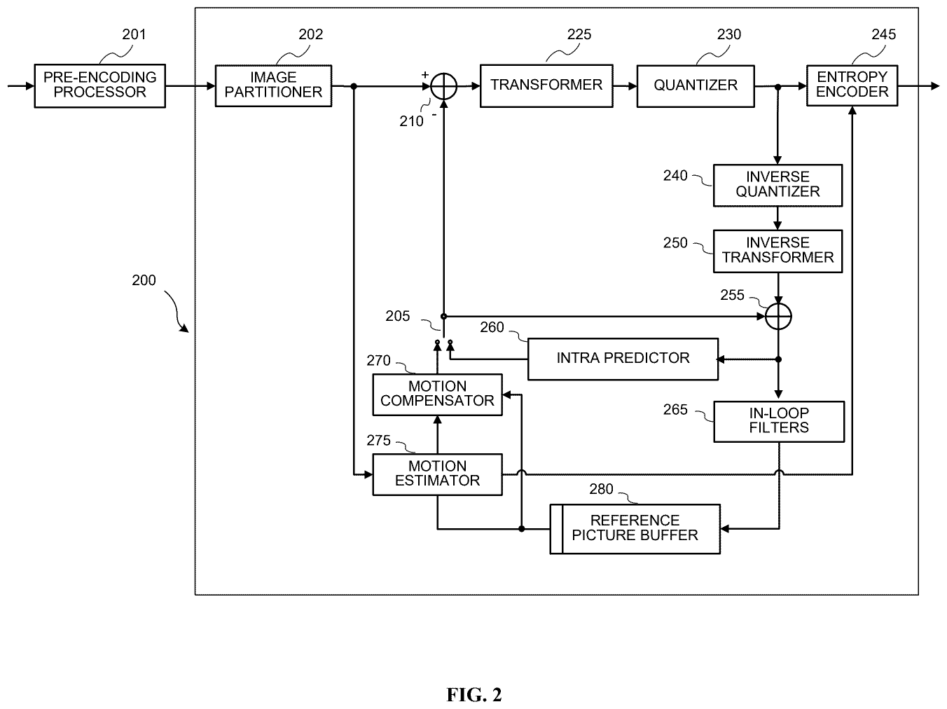

FIG. 2 illustrates a block diagram of an example video encoder 200 with which aspects of the present embodiments can be implemented. For example, the video encoder 200 can be an encoder that operates according to the High Efficiency Video Coding (HEVC) standard or an improved HEVC standard. Alternatively, the video encoder 200 can be an encoder that operates according to the Versatile Video Coding (VVC) standard that is under development by JVET (Joint Video Exploration Team).

In the present application, the terms “reconstructed” and “decoded” can be used interchangeably, the terms “encoded” or “coded” can be used interchangeably, and the terms “image,” “picture,” and “frame” can be used interchangeably. Usually, but not necessarily, the term “reconstructed” is used on the encoder side while the term “decoded” is used on the decoder side.

As shown in FIG. 2, prior to undergoing encoding, the video data can be pre-processed by a pre-encoding processor 201. Such processing can include applying a color model transform to the input color picture (e.g., conversion from RGB 4:4:4 to YCbCr 4:2:0), or performing a mapping of the input picture components in order to get a signal distribution that is more resilient to compression (for instance using a histogram equalization of one of the color components and/or applying a denoising filter). The pre-processing can include associating metadata with the video data that can be attached to the coded video bitstream.

In the encoder 200, a picture is encoded by the encoder elements as described below. A picture to be encoded can be partitioned into coding units (CUs) by an image partitioner 202. Each CU is encoded using, for example, either an intra or inter prediction mode. When a CU is encoded in an intra prediction mode, an intra prediction can be performed, by an intra predictor 260, to predict one CU in the frame based on data from another CU in the frame, the latter is a reconstructed version that can be fetched from a reference picture buffer 280. In an inter prediction mode, motion estimation and motion compensation are performed by a motion estimator 275 and a motion compensator 270, respectively. In the inter prediction mode, a CU in the frame is predicted based on one or more other CUs in neighboring frames, using their reconstructed versions that can be fetched from the reference picture buffer 280. The encoder decides 205 which one of the intra prediction mode or the inter prediction mode to use for encoding a CU, and indicates the intra/inter decision by, for example, a prediction mode flag. Following the operation, either under inter prediction mode or intra prediction mode, a prediction residual is calculated for each CU, for example, by subtracting 210 the predicted CU from the original CU.

The CUs' respective prediction residuals are then transformed and quantized by a transformer 225 and a quantizer 230, respectively. Then, an entropy encoder 245 encodes the quantized transform coefficients, as well as motion vectors and other syntax elements, outputting a coded video bitstream. The encoder 200 can skip the transform and apply quantization directly to the non-transformed residual signal. The encoder 200 can bypass both transform and quantization, that is, the residual can be coded directly without the application of the transform 225 or the quantization 230 processes.

The encoder 200 reconstructs the encoded CUs to provide a reference for further predictions. Accordingly, the quantized transform coefficients (output of the quantizer 230) are de-quantized, by an inverse quantizer 240, and then inverse transformed, by an inverse transformer 250, to decode the prediction residuals. Combining 255 the decoded prediction residuals and the respective predicted CUs, results in respective reconstructed CUs. In-loop filters 265 can be applied to the reconstructed picture (formed by the reconstructed CUs), to perform, for example, deblocking filtering and/or SAO (Sample Adaptive Offset) filtering to reduce encoding artifacts. The filtered reconstructed picture can then be stored in the reference picture buffer (280).

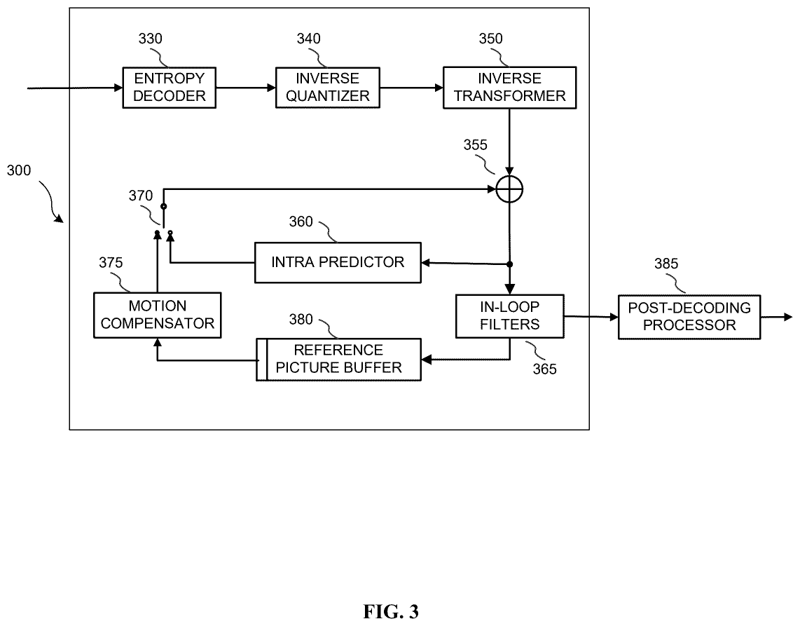

FIG. 3 illustrates a block diagram of an example video decoder 300 with which aspects of the present embodiments can be implemented. In the decoder 300, a decoded video bitstream is decoded by the decoder elements as described below. Generally, operational aspects of the video decoder 300 are reciprocal to operational aspects of the video encoder 200, described in reference to FIG. 2. Additionally, the encoder's 200 operation includes also decoding aspects 240, 250, through which the encoded pictures are reconstructed. The reconstructed pictures can then be stored in the reference picture buffer 280 and be used to facilitate motion estimation 275 and compensation 270, as explained above.

In particular, the decoder 300 is fed with input including a decoded video bitstream, generated by the video encoder 200, for example. The decoded video bitstream is first entropy decoded by an entropy decoder 330, decoding from the bitstream the quantized transform coefficients, motion vectors, and other data that can be encoded into the bitstream (such as data that indicate how the picture is partitioned). The quantized transform coefficients are de-quantized, by an inverse quantizer 340, and then inverse transformed, by an inverse transformer 350, to decode the CUs' prediction residuals. Combining 355 the decoded prediction residuals and respective predicted CUs, results in respective reconstructed CUs. The predicted CUs can be obtained 370 from an intra predictor 360 or from a motion compensator 375. In-loop filters 365 can be applied to the reconstructed picture (formed by the reconstructed CUs). The filtered reconstructed picture can then be stored in a reference picture buffer 380 to facilitate the motion compensation 375.

A post-decoding processor 385 can further process the decoded picture. For example, post-decoding processing can include an inverse color model transform (e.g., conversion from YCbCr 4:2:0 to RGB 4:4:4) or an inverse mapping to inverse the mapping process performed in the pre-encoding processor 201. The post-decoding processor 385 can use metadata that were derived by the pre-encoding processor 201 and/or were signaled in the decoded video bitstream.

Aspects disclosed herein are described in reference to a CU, however, the described aspects are applicable to any region in the video frame (i.e., video data region) that intra prediction can be applied to by an encoder 260 or a decoder 360. Thus, a CU (as referred to herein) is a video data region that can be formed by a video partition of any shape or size.

As mentioned above, the encoder 200 can perform intra prediction 260 when selecting to operate in an intra prediction mode with respect to a certain CU of a picture. A CU includes a luma component, Y, and chroma components, Cr and Cb (either one referred to herein also by C). Typically, a chroma component C is subsampled, and, so, has a reduced resolution relative to the corresponding luma component Y. Generally, the image content of a chroma component C is correlated with the image content of the corresponding luma component Y and its close spatial neighborhood. To take advantage of such cross-component correlation, approaches exist that predict a chroma sample from a chroma component C based on the corresponding luma sample derived from the reconstructed corresponding luma component Y. Several of these approaches, generally referred to herein as cross-component (CC) based predictions, are described below.

A CC-based prediction can rely on a linear model, namely, a CC linear model (CCLM) prediction. In a CCLM based prediction, chroma samples from the C component of a CU (coded in an intra prediction mode) are linearly predicted based on respective luma samples from the reconstructed and subsampled Y component of the CU, denoted Yrs. Thus, the linear prediction of a chroma sample at a pixel location (i, j) of the C component, that is, a chroma sample C(i, j), can be expressed as follows:

$${C}_{p} ( i , j ) = α \cdot {Y}_{rs} ( i , j ) + β , \qquad ( 1 )$$

where, Cₚ(i, j) indicates a predicted chroma sample at a pixel location (i, j) of the C component of the CU, and Yᵣₛ(i, j) indicates a luma sample at the pixel location (i, j) of the Yᵣₛ component of the CU. The model's parameters α and β can be estimated, for example, based of reference samples and by using a least-squares optimization algorithm that finds the parameters α and β that minimize the model's error. The model's error can be formulated as follows:

$$E ( n ) = {c}_{ref} ( n ) - ( α \cdot {y}_{ref} ( n ) + β ) , n ∈ 1 : N , \qquad ( 2 )$$

where, a pair of y_{ref}(n) and c_{ref}(n) indicates, respectively, a reference luma sample and a corresponding reference chroma sample, indexed by n∈1:N. And, where a pair of y_{ref}(n) and c_{ref}(n) reference samples are derived, respectively, from Y and C components of a reconstructed CU that is located in the vicinity of the CU for which the prediction is performed (according to (1)). Hence, a least-squares optimization algorithm finds the optimal values for α and β that minimize the sum of squared errors

$$E = {\sum }_{n = 1}^{N} {E ( n )}^{2} .$$

The N pairs of reference samples—that is, pairs (y_{ref}(n), c_{ref}(n)) for n∈1:N, can be selected according to different schemes, as further described below.

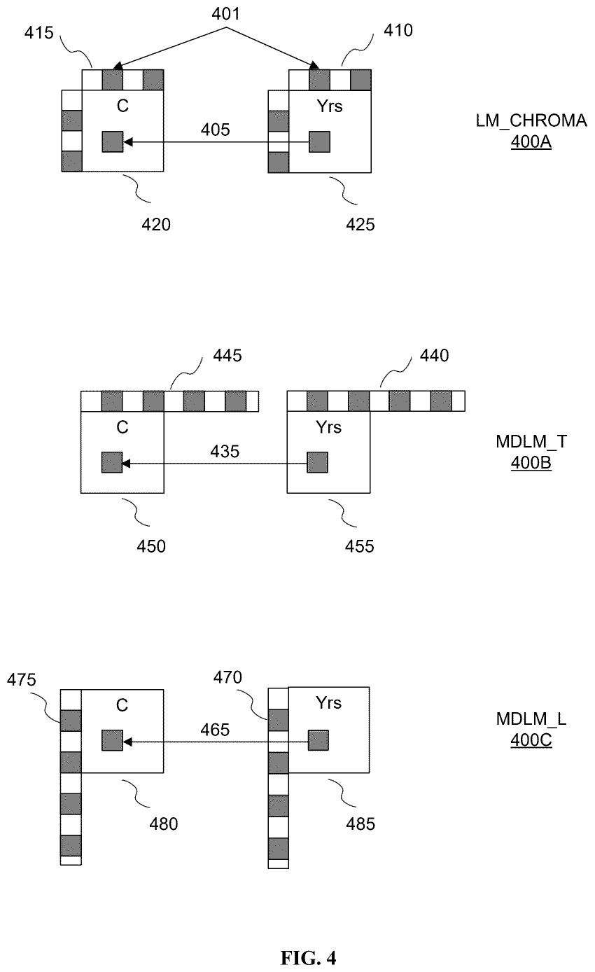

FIG. 4 is a diagram that illustrates a CCLM prediction mode used in CC based prediction, according to which aspects of the present embodiments can be implemented. A CCLM prediction mode is used in the Versatile Video Coding (VCC) standard (see, Versatile Video Coding, Standard ITU-T H.266, ISO/IEC 23090-3, 2020). As described above, in a CCLM prediction mode, a chroma sample from a C component 420, 450, 480 can be predicted by a corresponding luma sample from a corresponding subsampled reconstructed Yrs component 425, 455, 485, as illustrated in FIG. 4 by the arrows 405, 435, 465. At most four (N=4) pairs of reference samples (illustrated by the dark squares) are used in the VCC standard to predict the linear model parameters α and β, selected in accordance with three modes: LM_CHROMA mode 400A, MDLM_T mode 400B, and MDLM_L mode 400C. In the LM_CHROMA mode 400A, the four pairs of reference samples are selected from regions 410, 415 above and to the left of the CU. A pair of reference samples 401 is illustrated with respect to this mode 400A. In the MDLM_T 400B mode, the four pairs of reference samples are selected from regions 440, 445 above the CU. And, in the MDLM_L mode 400C, the four pairs of reference samples are selected from regions 470, 475 to the left of the CU.

Several variants to CCLM exist. The variation can be with respect to 1) the location and/or the number N of the reference pairs used to estimate the model's parameters α and β; 2) the method for estimating the model's parameters; or 3) the type of filter that is used when down-sampling the luma component Y into its down-sampled version Yᵣₛ. For example, when Enhanced Compression Model (ECM) is used (see, M.Coban, F.Le Leannec, K.Naser, J. Ström, “Algorithm description of Enhanced Compression Model 4 (ECM 4),” document JVET-Y2025, 23rd Meeting, by teleconference, 7-16 Jul. 2021), the CCLM included in the VVC is extended by adding three multi-model linear model (MMLM) modes (see, K.Zhang, J.Chen, L.Zhang, M.Karczewicz, “Enhanced Cross-component Linear Model Intra-prediction,” document JVET-D0110).

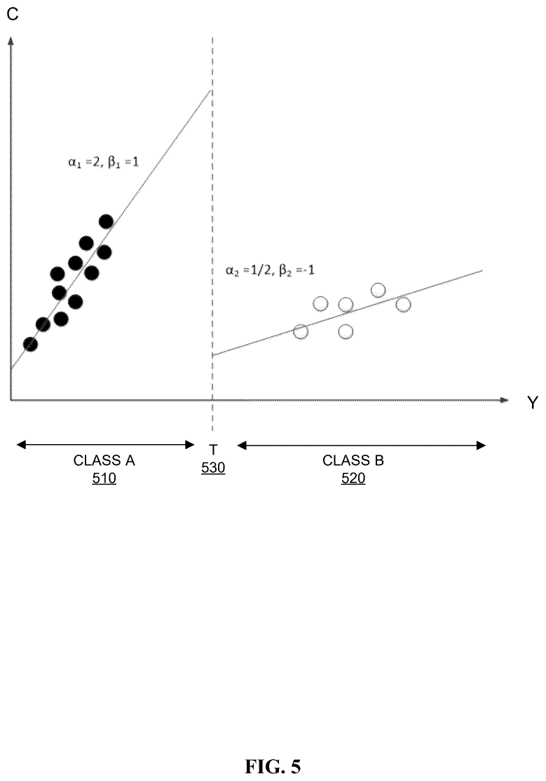

FIG. 5 is a diagram that illustrates a multi-model linear model (MMLM) used in CC based prediction, according to which aspects of the present embodiments can be implemented. In an MMLM, the N reference pairs (y_{ref}(n), c_{ref}(n)) are classified into multiple classes based on the pixel intensity level of respective luma samples y_{ref}(n). For example, in the case of two classes, class A 510 and class B 520, the reference pairs (y_{ref}(n), c_{ref}(n)) can be divided into two groups based on a threshold T 530. This threshold T can be determined based on the average of the pixel intensity levels of the N luma samples y_{ref}(n), for example. As illustrated in FIG. 5, samples that are below the threshold are classified in a first class 510 (denoted by dark circles) and samples that are above the threshold are classified in a second class 520 (denoted by hollow circles). The linear model associated with each class can be estimated (e.g., as described above) based on the reference pairs of each class—resulting in a first model with parameters α₁ and β₁ that are estimated based on reference pairs from class A 510 and a second model with parameters α₂ and β₂ that are estimated based on reference pairs from class B 520, as shown in FIG. 5. Accordingly, the first model can be used to predict a chroma sample with a corresponding luma sample that belongs to class A 510 and the second model can be used to predict a chroma sample with a corresponding luma sample that belongs to class B 520.

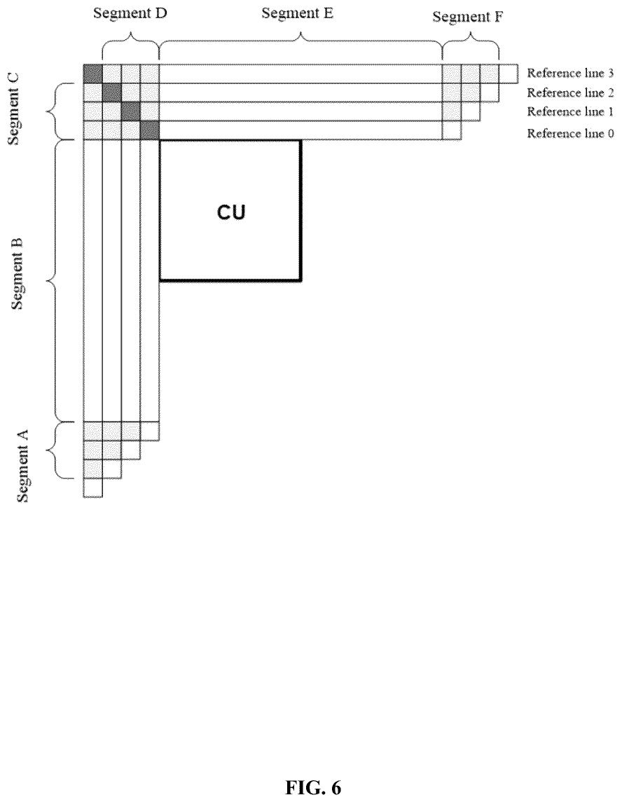

FIG. 6 is a diagram that illustrates a multiple reference line (MRL) used in CC based prediction, according to which aspects of the present embodiments can be implemented. In an MRL mode, reference pairs can be selected from multiple lines above (e.g., see lines within segments D, E, and F in FIG. 6) and to the left (e.g., see columns within segments C, B, and A in FIG. 6) of the CU. In the example shown in FIG. 6, samples from segment A and segment F can be padded with the closest samples from segment B and segment E, respectively. For example, in HEVC, in a CCLM mode, reference pairs are selected from the nearest reference line (reference line 0), where when an MRL mode is activated, reference pairs can also be selected from two additional lines (reference line 1 and reference line 3). The index of used reference lines can also be signaled.

A convolutional cross-component model (CCCM) is another approach for CC based predictions (see, P. Astola, J. Lainema, R. Youvalari, A. Aminlou, K. Panusopone, “AHG12: Convolutional cross-component model (CCCM) for intra prediction,” document JVET-Z0064, 26th Meeting, by teleconference, 20-29 Apr. 2022). Similar to CCLM, a CCCM can be used to predict chroma samples based on corresponding subsampled reconstructed luma samples. Also, similar to CCLM, there is an option of using a single model or multi-model variant of CCCM, as described with respect to FIG. 5. Preferably, multi-model CCCM mode can be selected when a large number of reference pairs (e.g., at least 128) are available.

The parameters of a CCCM include a 3×3 kernel K, a nonlinear term p, and a bias term q. The kernel K is a plus sign shaped kernel, having kernel coefficients k_{C}, k_{N}, k_{S}, k_{E}, k_{W} that are situated, respectively, at the center, north, south, east, and west of the pixel location that the kernel is convolved with. For example, convolving the kernel K with a sample Yᵣₛ(i, j), the filter output Yᵣₛ(i, j)*K is:

$${Y}_{rs} ( i , j ) \cdot {k}_{C} + {Y}_{rs} ( i , j - 1 ) \cdot {k}_{N} + {Y}_{rs} ( i , j + 1 ) \cdot {k}_{S} + {Y}_{rs} ( i - 1 , j ) \cdot {k}_{W} + {Y}_{rs} ( i + 1 , j ) \cdot {k}_{E} . \qquad ( 3 )$$

The nonlinear term p can be determined as the power of two of Yᵣₛ(i, j) that is scaled to the used bit depth. For example, for a bit depth of 10 bits, the nonlinear term p is:

$$p ≡ P ( {{Y}_{rs} ( i , j )}^{2} ) = ( {{Y}_{rs} ( i , j )}^{2} + 512 ) ≫ 10. \qquad ( 4 )$$

The bias term q can be determined as the middle chroma value (e.g., 512 for 10-bit content).

Hence, the CCCM model can be expressed as follows:

$${C}_{p} ( i , j ) = {Y}_{rs} ( i , j ) * K + a \cdot P ( {{Y}_{rs} ( i , j )}^{2} ) + b \cdot q , \qquad ( 5 )$$

Note that Cₚ(i, j) can be further clipped to the range of a valid chroma sample. Thus, the CCCM model parameters are A≡(k_{C}, k_{N}, k_{S}, k_{W}, k_{E}, a, b). Similar to the CCLM, these parameters can be estimated by minimizing the model's error, as follows:

$$E ( n ) = {c}_{ref} ( n ) - ( {y}_{ref} ( n ) * K + a \cdot P ( {{y}_{ref} ( n )}^{2} ) + b \cdot q ) , n ∈ 1 : N , \qquad ( 6 )$$

where, a pair of y_{ref}(n) and c_{ref}(n) indicates, respectively, a reference luma sample and a corresponding reference chroma sample, indexed by n∈1:N. And, where a pair of y_ref(n) and c_{ref}(n) reference samples are derived, respectively, from Y and C components of a reconstructed CU that is located in the vicinity of the CU for which the prediction is performed (according to (5)). Hence, a least-squares optimization algorithm can be used to find the optimal values for (k_{C}, k_{N}, k_{S}, k_{W}, k_{E}, a, b) that minimize the sum of squared errors E=

$${\sum }_{n = 1}^{N} {E ( n )}^{2} .$$

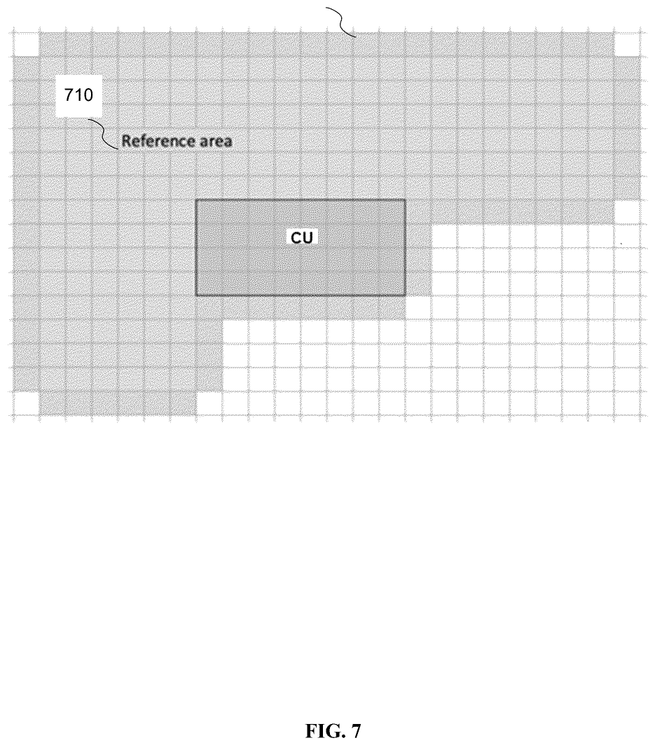

The N reference pairs y_{ref}(n) and c_{ref}(n) can be selected from a reference area, as further explained with reference to FIG. 7.

In an aspect, minimizing the sum of squared errors can be performed by calculating an autocorrelation matrix for the luma reference samples y_{ref}(n) and a cross-correlation matrix between the luma reference samples y_{ref}(n) and the chroma reference samples c_{ref}(n). Then, the autocorrelation matrix is LDL decomposed and the CCCM model parameters are calculated using back-substitution. This process is similar to the calculation of the ALF filter coefficients in ECM, however an LDL decomposition is used instead of a Cholesky decomposition to avoid using square root operations. Advantageously, this calculation uses only integer arithmetic.

FIG. 7 is a diagram that illustrates a reference area that can be used by a CCCM, according to which aspects of the present embodiments can be implemented. As shown in FIG. 7, to estimate the CCCM parameters, reference pairs can be selected from a reference area 710, consisting of 6 lines above the CU and 6 columns to the left of the CU. However, in this case, a padding area 720 (used for reference pairs located along the boundary of the reference area 710) is also used to support a convolution by the 3×3 kernel K. For each CU, the area 710, 720 is determined to include only available samples. Samples in area 720, can be padded if not available.

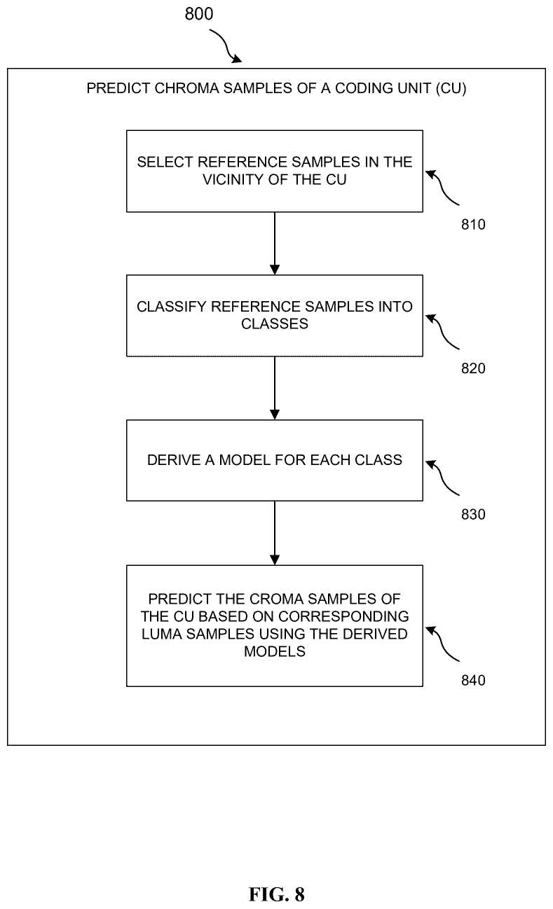

The above-described approaches to CC based predictions—using CCLM, MMLM, and CCCM—are generally described in reference to FIG. 8.

FIG. 8 is a flowchart for an example method for CC based prediction 800, according to which aspects of the present embodiments can be implemented. The CC based prediction, described with respect to a chroma component C of a CU, provides for the prediction of chroma samples from C based on corresponding luma samples from the reconstructed and subsampled luma component Yᵣₛ of the CU. According to aspects described herein, the method 800 begins, in step 810, by selecting reference samples—for example, N reference pairs y_{ref}(n) and c_{ref}(n). The number N of the reference samples and the region (in the vicinity of the CU) from which the reference samples are selected can vary, for example, as described in reference to FIGS. 4, 6, and 7. In step 820, optionally, the reference samples can be classified to into multiple classes or kept in the same one class, as described in reference to FIG. 5. In step 830, a model is derived with respect to each class. Accordingly, for each class' model, the model parameters are estimated based on the reference samples from the respective class. Then, in step 840, a chroma sample from C can be predicted based on the corresponding luma sample from Yᵣₛ using the model (derived in step 830) that is associated with the class that the luma sample belongs to.

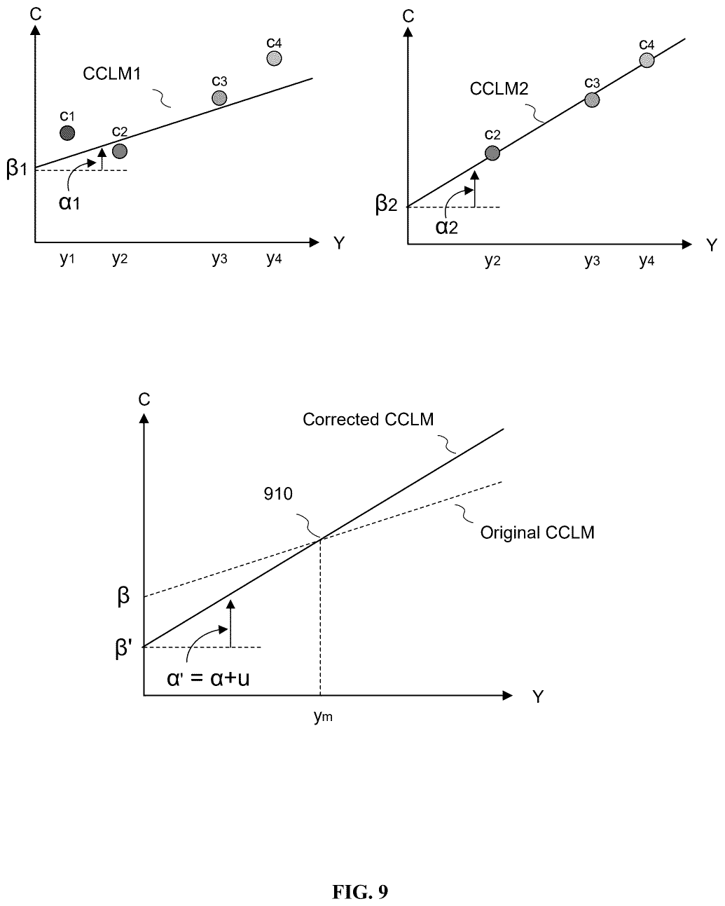

The accuracy of the CC based predictions depends on how well the luma reference samples (the N selected luma samples y_{ref}(n)) statistically represent the luma samples in the CU. For example, in the case of the CCCM, the model parameters are derived based on reference samples selected from a reference area 710 in the neighborhood of the CU (see FIG. 7). However, the image characteristics (statistics) of the luma reference samples can differ from the image characteristics of the luma samples in the CU to an extent that may impact the accuracy of the prediction the model provides. Thus, to reduce the model's prediction error, a correction can be signaled by the encoder 200 when encoding a CU in an intra prediction mode 260. The signaled correction can be applied by the decoder 300 when decoding the CU 360. In the case of CCLM, the aforementioned problem is tackled by signaling a correction to the slope α of the linear model (see, J. Lainema, A. Aminlou, P. Astola, R. Youvalari, “EE2-1.1: Slope adjustment for CCLM”, document JVET-Z0049, 26th Meeting, by teleconference, 20-29 Apr. 2022), as further described in reference to FIG. 9.

FIG. 9 is a diagram that illustrates a correction to a CCLM, according to which aspects of the present embodiments can be implemented. Assuming that the reference luma samples that are used to estimate a linear model for a certain CU are y₁, y₂, y₃, and y₄, and their corresponding chroma samples c₁, c₂, c₃, and c₄ (see the linear model, denoted CCLM1, in FIG. 9). Then, assuming that the luma samples in the Yᵣₛ component of the CU do not include luma samples of value y₁, a linear model that is estimated based on reference luma samples including only y₂, y₃, and y₄, and their corresponding chroma samples c₂, c₃, and c₄ will be more accurate (see the linear model, denoted CCLM2, in FIG. 9). Thus, to reduce the error of chroma sample prediction, the slope α of the respective linear model can be corrected by a value u. The graph at the bottom of FIG. 9 shows the correction that can be applied to an original CCLM (dotted line), resulting in the corrected CCLM (solid line). For example, the original CCLM can be CCLM1 that is corrected to result in the more accurate CCLM2 (that is, the corrected CCLM). The corrected slope, denoted by α′=α+u, is determined while maintaining a corrected offset β′ so that the line of the corrected linear model (solid line) is fixed 910 at point y=yₘ, where yₘ indicates the average of the observed luma samples (the luma reference samples used in estimating the model parameters). That is, u and β′ are determined so that the model's error is reduced and so that the following relation is at least closely maintained:

$$( {α}^{′} \cdot {y}_{m} + {β}^{′} ) = ( α \cdot {y}_{m} + β ) . \qquad ( 7 )$$

The correction to the slope, u, is signaled to the decoder. However, the correction to the offset, β′, can be deduced by the decoder based on eq. 7.

As disclosed herein, a correction can be signaled in the case where a CCCM is used. As described above, the CCCM model parameters are A=(k_{C}, k_{N}, k_{S}, k_{W}, k_{E}, a, b) (see eq. 5). Various aspects of correcting the CCCM are described below.

In a first aspect, a correction U≡(u₁, u₂, u₃, u₄, u₅, u₆, u₇) is signaled with respect to all the parameters. Accordingly, A is corrected into:

$$\begin{matrix}{A}^{′} = ( {k}_{C} + {u}_{1} , {k}_{N} + {u}_{2} , {k}_{S} + {u}_{3} , {k}_{W} + {u}_{4} , {k}_{E} + {u}_{5} , a + {u}_{6} , b + {u}_{7} ) \\ = ( {k}_{C}^{′} , {k}_{N}^{′} , {k}_{S}^{′} , {k}_{W}^{′} , {k}_{E}^{′} , {a}^{′} , {b}^{′} ) \\ = ( {K}^{′} , {a}^{′} , {b}^{′} )\end{matrix} \qquad ( 8 )$$

Signaling a correction to each of the model's parameters offers the greatest flexibility in terms of reducing the model's error, at the cost of transmitting the additional bits that encodes U. In a variant, the correction u₇ for the offset b can be deduced from the other corrections. Similar to the linear model (see eq. 7), this can be done by maintaining:

$${Y}_{m} * {K}^{′} + {a}^{′} \cdot P ( {y}_{m}^{2} ) + {b}^{′} \cdot q = {Y}_{m} * K + a \cdot P ( {y}_{m}^{2} ) + b \cdot q \qquad ( 9 )$$

where yₘ indicates the average of the observed luma samples (the luma reference samples used in estimating the model parameters), and where Yₘ indicates a 3×3 matrix with all elements equal to yₘ. Accordingly, the correction u₇ for the offset b can be obtained by the decoder by:

$${u}_{7} = ( - ( {u}_{1} + {u}_{2} + {u}_{3} + {u}_{4} + {u}_{5} ) \cdot {y}_{m} - {u}_{6} \cdot p ( {y}_{m}^{2} ) ) / q \qquad ( 10 )$$

In a second aspect, a correction for only one parameter of the CCCM can be signaled. That is, any of u₁, u₂, u₃, u₄, u₅, u₆ or u₇ can be signaled. Signaling a correction to only one of the model parameters offers less flexibility in terms of reducing the model's error, however, it can allow transmitting a larger correction for the same number of bits. In a variant, only the correction to the first coefficient, u₁, is signaled. In another variant, the index of the parameter to be corrected is first transmitted, followed by the respective correction (e.g., signaling index=1 and u₁). In another variant, the parameter to be corrected is the largest one in absolute value; this can be deduced on the decoder side, therefore, signaling the index of the corrected parameter is not required in this case. In another variant, the correction to the offset, u₇, can be deduced, for example, by using eq. (10), where in this case only the one signaled correction (one of u₁, u₂, u₃, u₄, u₅, u₆) can be plugged-in in this equation.

In a third aspect, a correction including one value u, to be applied to all the CCCM parameters, can be signaled. For example, the same value of u can be signaled and used to correct all the seven parameters—that is, the values of u₁, u₂, u₃, u₄, u₅, u₆ and u₇ can be all set to u. Signaling one correction value in this manner offers less flexibility in terms of reducing the model's error, however, it can allow transmitting a larger correction for the same number of bits. In a variant, the values of u₁, u₂, u₃, u₄, u₅ and u₆ are set to u, and the offset correction u₇ is obtained according to eq. (10), that in this case becomes: u₇=−u(5yₘ+P(yₘ²))/q.

Correction value(s) are determined so that when applied to the CC model, the model's prediction accuracy is improved. For example, the correction value(s) can be determined by the encoder through an exhaustive search among all possible correction value(s). The correction value(s) that yield the best prediction performance (or least prediction error) for the CU are then selected and coded in the bitstream of the decoded video.

In the adopted technology of ECM software, 8 possible values of the correction u can be signaled. The 8 values correspond to − 4/4, −¾, − 2/4, −¼, ¼, 2/4, ¾, and 4/4 of the maximum possible value for u. This results in a 3-bit code that can be used to encode u. Alternatively, and as disclosed herein, u can be coded by 1 or 2 bits (resulting in 2 or 4 possible values, respectively), reducing the signaling overhead while allowing the encoder to signal a correction for the model's parameters. Accordingly, the values of the model's parameters are examined to decide on the respective value of the signaled corrections. Thus, a correction value u (e.g., any of the parameters u₁, u₂, u₃, u₄, u₅, u₆ and u₇) can be obtained by multiplying the signaled correction s (that is, a relative correction value which can be either positive or negative) by precision adjustment x (e.g., 0.1 or 0.25) and/or the absolute value of the respective model parameter. For example, for u=u₁, the correction value is derived from the signaled correction s through the following expression:

$${u}_{1} = s * x * abs ( {k}_{C} ) \qquad ( 11 )$$

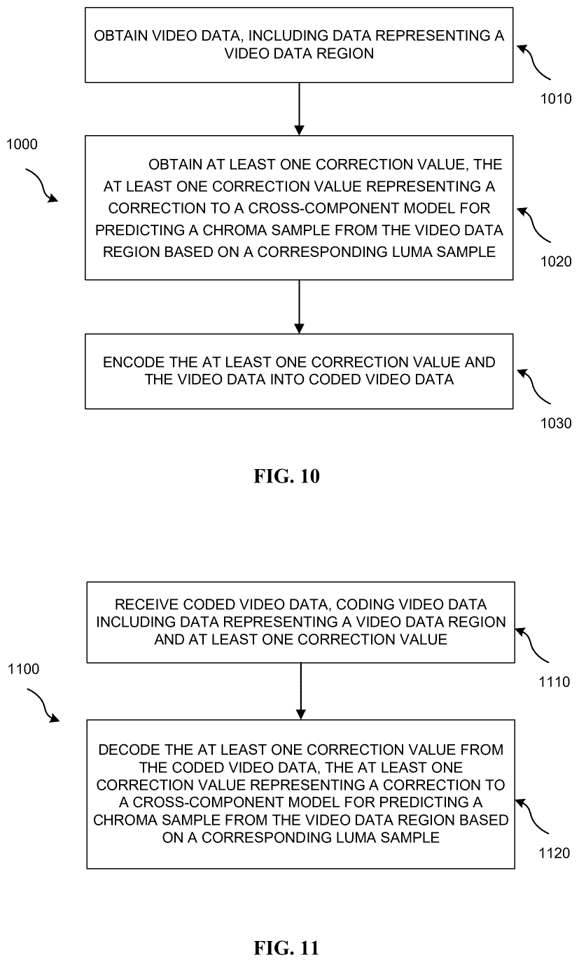

FIG. 10 is a flowchart of an example method for encoding video data 1000, according to which aspects of the present embodiments can be implemented. The method 1000 can be carried out by the encoder 200, as described herein. The method 1000 begins, in step 1010, with obtaining video data, including data representing a video data region. The video data, as referred to herein, can include image data and/or respective syntax data, transform coefficients, and residuals. The video data region, referred to herein as a CU, can be a video block or any video region for which an intra prediction can be applied to. In step 1020, at least one correction value is obtained. The at least one correction value represents a correction to a cross-component model for predicting a chroma sample from the video data region based on a corresponding luma sample. Then, in step 1030, the at least one correction value and the video data are encoded into coded video data.

FIG. 11 is a flowchart of an example method for decoding video data 1100, according to which aspects of the present embodiments can be implemented. The method 1100 can be carried out by the decoder 300, as described herein. The method 1100 begins, in step 1110, with receiving coded video data, coding video data including data representing a video data region and at least one correction value. In step 1120, the at least one correction value from the coded video data is decoded. The at least one correction value represents a correction to a cross-component model for predicting a chroma sample from the video data region based on a corresponding luma sample. The cross-component model can then be adjusted based on the at least one correction value. Furthermore, chroma samples from the video data region can be predicted based on the adjusted cross-component model.

The above described techniques for correcting CCCM model are applicable to any cross component model, including multiple coefficients in addition to an offset coefficient. Likewise, the above described techniques for correcting CCCM model are applicable to any non-linear or linear cross component model.

We have described several aspects and embodiments in the present disclosure. These aspects and embodiments provide at least the following outputs and results, including all combinations, across different claim categories and types:
Encoding, into coded video data, syntax elements that can enable the decoder to adjust the parameters of a CC model associated with intra prediction that is applied to a CU, according to any of the aspects described herein.
A bitstream that includes one or more of the described syntax elements, or variations thereof. A bitstream can be any set of data whether transmitted, stored, or otherwise made available.
Creating, transmitting, receiving, and/or decoding of the bitstream.
An electronic device (e.g., a TV, a set-top box, a cell phone, and a tablet) that tunes (e.g., using a tuner) a channel to receive the bitstream or that receives (e.g., using an antenna) the bitstream over the air. The electronic device decodes the syntax elements from the bitstream, and, optionally, displays (e.g., using a monitor, screen, or any other type of display) a resulting image.
   Various other generalized, as well as particularized, outputs, results, implementations, and claims are also supported and contemplated throughout this disclosure.

Various methods are described herein, and each of the methods comprises one or more steps or actions for achieving the described method. Unless a specific order of steps or actions is required for the proper operation of the method, the order and/or use of specific steps and/or actions can be modified or combined. Additionally, terms such as “first”, “second”, etc. can be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and can occur, for example, before, during, or in an overlapping time period with the second decoding.

Various methods and other aspects described in this application can be used to modify modules, for example, the modules of the video encoder 200 and the video decoder 300 as shown in FIG. 2 and FIG. 3. Moreover, the present aspects are not limited to VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video data in order to produce an encoded bitstream.

Note that the syntax elements as used herein are descriptive terms. As such, they do not preclude the use of other syntax element names.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
a. SDP (session description protocol), a format for describing multimedia communication sessions for the purposes of session announcement and session invitation, for example as described in RFCs and used in conjunction with RTP (Real-time Transport Protocol) transmission.
b. DASH MPD (Media Presentation Description) Descriptors, for example as used in DASH and transmitted over HTTP, a Descriptor is associated with a Representation or collection of Representations to provide additional characteristics to the content Representation.
c. RTP header extensions, for example as used during RTP streaming.
d. ISO Base Media File Format, for example as used in OMAF and using boxes which are object-oriented building blocks defined by a unique type identifier and length also known as ‘atoms’ in some specifications.
e. HLS (HTTP live Streaming) manifest transmitted over HTTP. A manifest can be associated, for example, with a version or collection of versions of a content to provide characteristics of the version or collection of versions.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application can refer to “determining” various pieces of information. Determining the information can include one or more of, for example, estimating the information, calculating the information, predicting the information, or retrieving the information from memory.

Further, this application can refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application can refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

1-28. (canceled)

29. A method comprising:
receiving video data, including data representing a video data region;
obtaining at least one correction value, correcting a coefficient of a plurality of coefficients defining a cross-component (CC) model, the CC model is used for predicting a chroma sample from the video data region based on a corresponding luma sample; and
encoding, into a bitstream coding the video data, the at least one correction value and an index indicating the coefficient being corrected.

30. The method according to claim 29, further comprising:
obtaining a correction to an offset coefficient of the CC model based on the at least one correction value.

31. The method according to claim 29, wherein the at least one correction value comprises:
a relative correction value that, when multiplied by the coefficient, results in a corrected coefficient.

32. The method according to claim 29, wherein the at least one correction value comprises:
a relative correction value that, when multiplied by the coefficient and by a precision adjustment, results in a corrected coefficient.

33. The method according to claim 29, wherein the CC model is a non-linear model.

34. The method according to claim 29, wherein the at least one correction value comprises a correction value for each of the plurality of coefficients of the CC model.

35. The method according to claim 29, wherein the at least one correction value comprises one correction value used to correct more than one of the plurality of coefficients of the CC model.

36. The method according to claim 29, wherein the at least one correction value is used to correct the largest coefficients of the plurality of coefficients of the CC model.

37. An apparatus, comprising:
at least one processor; and
memory storing instructions that, when executed by the at least one processor, cause the apparatus to perform the method of claim 29.

38. A non-transitory computer-readable medium comprising instructions executable by at least one processor to perform the method of claim 29.

39. A method comprising:
receiving a bitstream, coding video data including data representing a video data region; and
decoding from the bitstream at least one correction value, correcting a coefficient of a plurality of coefficients defining a cross-component (CC) model, and an index indicating the coefficient being corrected,
wherein the CC model is used for predicting a chroma sample from the video data region based on a corresponding luma sample.

40. The method according to claim 39, further comprising:
obtaining a correction to an offset coefficient of the CC model based on the at least one correction value.

41. The method according to claim 39, wherein the at least one correction value comprises:
a relative correction value that, when multiplied by the coefficient, results in a corrected coefficient.

42. The method according to claim 39, wherein the at least one correction value comprises:
a relative correction value that, when multiplied by the coefficient and by a precision adjustment, results in a corrected coefficient.

43. The method according to claim 39, wherein the CC model is a non-linear model.

44. The method according to claim 39, wherein the at least one correction value comprises a correction value for each of the plurality of coefficients of the CC model.

45. The method according to claim 39, wherein the at least one correction value comprises one correction value used to correct more than one of the plurality of coefficients of the CC model.

46. The method according to claim 39, wherein the at least one correction value used to correct the largest coefficients of the plurality of coefficients of the CC model.

47. An apparatus, comprising:
at least one processor; and
memory storing instructions that, when executed by the at least one processor, cause the apparatus to perform the method of claim 39.

48. A non-transitory computer-readable medium comprising instructions executable by at least one processor to perform the method of claim 39.
